(19) United States
(12) Patent Application Publication
(10) Pub. No.: US 2012/0127297 A1
(43) Pub. Date: May 24, 2012

(54) DIGITAL MICROSCOPY WITH FOCUS GRADING IN ZONES DISTINGUISHED FOR COMPARABLE IMAGE STRUCTURES

(76) Inventors: Vipul A. Baxi, Freehold, NJ (US); Richard R. McKay, East Windsor, NJ (US); Michael C. Montalto, Brielle, NJ (US); Dirk R. Padfield, Albany, NY (US); Dashan Gao, Rexford, NY (US)

(21) Appl. No.: 12/954,108

(22) Filed: Nov. 24, 2010

(51) Int. Cl. H04N 7/18; G06K 9/34; G06K 9/46

(52) U.S. Cl. 348/79; 382/190; 382/173

(57) ABSTRACT

Digital image quality is assessed, especially focus accuracy for a microscopic pathology sample image, using quality assessment criteria that differ among zones distinguished by a structural classification process. An image or area is divided into sub-regions such as adjacent pixel blocks. At least one metric or algorithm is applied, such as a Brenner gradient correlated with focus quality or a Laplacian transform correlated with structural difference. Spatial zones are distinguished by associating blocks of pixels that produced comparable values from the metric. The quality results of an objective metric such as the Brenner gradient are graded separately using statistical or pass/fail grading criteria in each spatial zone, independent of other zones. Focus quality across the image is mapped for display and/or used to queue a re-imaging step.

### BACKGROUND

This disclosure concerns grading the quality of areas in a digital image, and is applicable during automated production and review of images of pathology and histology samples from microscopic imaging of tissue sample slides.

When reviewing tissue samples using a traditional manually adjusted optical microscope, a pathologist operates by setting a sample mounted on a glass slide onto a stage of the microscope. The pathologist views the slide while adjusting the X-Y position of the slide, selecting a magnification, and adjusting the distance between the specimen and the optics to find and maintain the focal distance that causes the specimen to appear in focus through the optics. This is done using knobs and similar manual controls.

A tissue sample can have structural features of various sizes, visible as traits in the image, that vary due to differences in local tissue structures. Some features are characterized by a substantial amount of inherent contrast, and other features are inherently relatively indistinct. The pathologist using a microscope allots his or her viewing time and attention appropriately, perhaps increasing magnification and fine tuning the focus so as to obtain a good view of features of interest, while passing over mundane features quickly or at lower magnification.

The optics of a manually controlled optical microscope are such that the image is in focus when the surface of the subject being viewed is located at a correct distance from the objective lens or lens array, i.e., in the focal plane. Adjusting the focus entails varying the relative distance between the objective lens and the sample, thereby moving features of interest into the focal plane. For example, the stage holding the sample may be movable toward or away from the mounting of the objective lens, or vice versa. When viewing the sample through the microscope and adjusting for focus using a control knob, one typically moves the distance up to and through the correct distance and then back again, homing in on the correct focal distance by adjusting to obtain the sharpest image available for some point of interest on the sample. After manually dithering through the focal distance in this way, the operator has some confidence that the sample has been viewed for all that it reveals, namely in the best focus available from the instrument. The process also accommodates the topography of the surface of the sample, which may have differences in elevation.

Digital microscopy systems are being introduced wherein tissue samples are prepared in the usual way of being mounted on glass slides, but instead of having the pathologist view the samples using a manually controlled optical microscope, the slides are processed using digital cameras coupled to microscope optics. Incremental stage positioning controls step the field of view across the surface of the slides and digital cameras or scanners collect images of the sample. A set of images can be collected at different resolutions. A set of laterally adjacent images can be collected at high resolution and combined, e.g., by merging or “stitching” together the data of pixels at the edges of adjacent images corresponding to the same points on the sample. The result is a composite image that encompasses an array of many small image frames that can be navigated using a digital display terminal.

The pathologist views the digitized images of the slides on a computer workstation, using the zoom and pan functions of image display software to navigate the sample. A disclosure of collecting and stitching together high resolution images of adjacent square or rectangular areas, sometimes known as “tiles,” is disclosed, for example, in published U.S. application 2008/0240613, the disclosure of which is hereby incorporated. It is also possible to scan over the sample to collect images of elongated strips that are aligned along their lateral sides, and optionally merged or stitched.

The foregoing digital display technique has many of the capabilities of viewing a slide by manual control of an optical microscope, and also additional advantages. For example, the digital data can be stored indefinitely as a permanent record. Image data can be retrieved and transmitted readily using network communications. Digital images of slides can be organized and reviewed more efficiently than the glass slides themselves. However the process generally does not involve the capability of reviewing and comparing multiple images at different focal distances. One image is recorded for each frame over the sample. It would be advantageous if the person viewing the image could have a useful way to assess the quality of the image, in particular whether the image is in good focus, independently of the content and whether or not the tissue structure has high inherent contrast.

It would be possible in a digital pathology system to record multiple images of the same area of a sample at slightly different focal distances, with the imaged surface of the sample being slightly above, slightly below and preferably precisely at the focal distance of the microscope optics. With a sufficient number of views and organized image processing, this would enable a person viewing images on a computer workstation to progress through images at slightly different focal distances, in the same way that a user of an optical microscope dithers the focal distance adjusting knob to seek the distance with the best focus. But the volume of data needed for high resolution sample imaging is already quite high, and recording multiple images would increase the data to be recorded and managed. In a process comprising collecting views at or near to the correct focal distance, and also collecting additional views, some of the views are not in good focus and are not worth saving.

Instead of recording multiple images at different focal distances, an autofocusing system is employed to assist in recording one image nominally in good focus. Autofocusing can be undertaken for each image frame to be recorded. The autofocusing system typically mathematically compares the levels of contrast in two or more images of the same portion of the sample at two or more focal distances. Inasmuch as the content of the images is the same and only the focal distance differs, one can conclude that a higher degree of measured contrast, such as a higher average difference in luminance amplitude between adjacent or nearby pixels, indicates more accurate focus. Although plural digital images may be obtained and compared by the autofocus system, only the image with the best focus for each frame is recorded and stored.

An exemplary autofocus control is disclosed in U.S. Pat. No. 7,576,307—Yazdanfar et al., hereby incorporated by reference. This autofocus control uses primary and secondary imaging sensors. A positioning control varies the focal length and an image processor mathematically evaluates the contrast found in two or more images of the same content, selecting for a primary image in best possible focus. The selected image becomes a frame element (such as a mosaic tile) representing that local area, and is merged or stitched at its edges with adjacent frames or tiles to form a composite image of the sample. When collecting images for the adjacent and other tiles, autofocusing steps are employed again, independently selecting the best focal distance for each tile or other individual frame. The best focal distances for different tiles or frames may be at different focal distances, accounting for differences in the topography of the sample, tilt of the stage or the mounting of the sample on the slide, etc. By separately focusing and collecting one image for each tile of frame in a composite image of many tiles or frames, the total amount of collected image data is reasonably limited and the composite is generally in reasonably good focus. However, the pathologist who uses the image data does not have the ability to dither the focal plane and the quality of the image may be better at some points on the composite image than others.

It would be advantageous to provide a way for the user to satisfy himself that a given point on the composite image is of sufficient quality to serve the user's needs. Image assessment algorithms are known, but generally are based on objective algorithms. Therefore, the output values that are produced by the algorithms (namely the assessments) vary not only with focus but also with variation of the content of the image. Objective algorithms require comparison of two or more images representing the same image content, usually images at different focal distances, so that the two or more images provide references for comparison with one another free of differences in content. A challenge is presented when attempting to assess image quality independent of image content, operating on one image version only. It is not a solution simply to compare the results of an objective image assessment algorithm at different positions in the composite image because the image content can be different at different positions in the same image, e.g., with local areas of different inherent contrast. A single image of a tissue sample may have a local area, for example, with striations or the like characterized by a high degree of inherent contrast, and a different local area that is continuously shaded and there is little inherent contrast. An objective assessment without a reference would conclude that that the higher contrast striated area is in better focus than the lower contrast shaded area even if the opposite is actually the case.

A pathologist using a manual microscope makes a comparison of image sharpness from different focal distances when adjusting the instrument, which is somewhat like an objective algorithm producing numerical values that vary with contrast for two or more images at different focal distances. Pathologists also look for a degree of clarity expected of structural features and shapes found in certain tissue types. Shapes may include, for example, generally aligned straight or waved lines, circles or blobs that may be found in some tissue samples, etc. Shape and structure-sensitive mathematical algorithms are known for producing a numeric value that varies with the presence or absence in the image of a shape that the algorithm is designed to reveal. An algorithm may be designed to produce a score that discriminates for the presence of particular shapes (e.g., straight lines, arcs, angles, circles or blobs, etc.) and/or shapes only of a particular size or other characteristic.

Examples of shape variations include skin tissue, wherein some parts of a sample may exhibit indistinct stroma and other parts of the same sample show distinct cell boundaries. Vascular tissue in a sample may have distinct edge features compared to non-vascular tissue in the same sample. Bone tissue is typically different in cross sectional structure due to density variations (e.g., vacuoles) with a scale and density that differ across the sample. These are instances in which there are differences in the structural content of tissue that results in images that are more or less distinct due to differences in the content or image structure present in an image.

A shape or structure sensitive algorithm is an objective algorithm just as average contrast and similar algorithms are objective. It is not possible to use the results of objective algorithms to compare images or areas of images wherein the tissue type is different and the structural features that are encountered are different. The outputs of objective algorithms sensing for shape or for contrast vary with the content of the image while also varying with the parameter being sensed (such as accuracy of contrast or relative density of blobs of a given size, etc.). Such algorithms need to compare two images of the same content. What is needed is a way to apply these algorithms in a way that is useful to assess local image quality when only one image is present, and the image content may vary across the area of the image.

One example of an assessment of the contrast in an image comprises obtaining the numeric difference between a luminance value of each pixel and its adjacent pixels. The differences represent a measure of local contrast and are summed or averaged (integrated) over all or part of the image area. The difference assessment may be done for regions such as regular blocks of pixels. The blocks may be larger or smaller, down to a difference assessment for every pixel position versus its neighboring pixels. The difference assessment can be scaled in size to produce a measure of the difference between pixel values and their neighboring pixels that are spaced apart by a given number of pixel positions, thereby being sensitive to variations that are of a given scale.

If the difference or integrated sum of differences is compared against the sum obtained for an alternative image of the very same scene or content, taken at a different focal length, then one can conclude that the image producing the higher sum is in better focus than an image of the same content that produces a lower sum. But if the sums of differences for images with different content are compared, or if different local areas of a given image are compared, no conclusion can be reached. The different numerical assessments (such as average local contrast) may be due to differences in image content rather than focus accuracy.

The foregoing situation describes focal plane depth and focus issues assessed by objective measures of pixel contrast. This is one example of the more general issue of choosing among the alternative conditions that are used to collect one digital image of a sample, when adjusting conditions in which the image is recorded might affect image quality, and using an objective measure that correlates with an aspect of quality such as focus. Other examples of variables affecting quality include front and/or rear lighting or lighting amplitude, illumination spectra, polarization conditions, image collection time, aperture and depth of field, etc. Typical image collection processes employ nominal conditions or in the case of autofocus use a controller to seek or select perceived optimal conditions by comparing alternatives for the same image content, but can result in variations in the quality of one tile or other individually collected image frame versus another, and variations across the area of a composite image, wherein the variations are not merely a matter of differences in image content.

Published patent application U.S. 2008/0273788—Soenksen, hereby incorporated by reference, discloses that it if a microscopic pathology slide is found to be defective, for example due to improper light level or stain application (detected by failing to meet an unspecified set of predetermined criteria), the slide can be rejected, the specimen can be queued to be re-imaged, or for some defects an image processing procedure can be applied to reprocess the image numerically and thereby correct the deficiency (e.g., to increase or decrease the apparent level of illumination). These techniques might result in an image being rejected for poor focus quality. However poor focus quality is not readily detected for the reasons discussed above, and typically cannot be corrected by routine image processing steps. What is needed is a set of predetermined criteria to assess image quality of a single image, including but not limited to focus quality, wherein the assessment is independent of the inherent variation that occurs within images due to the difference in appearance of different features in the image.

Image processing techniques are known for enhancing the detectability of particular structures in an image. Edge detection algorithms, scalable detectors for bodies or “blobs” of equal size or shape, and detectors for discrete features or “corners” are known. The algorithms can produce transforms from images that when processed produce a measure of the extent to which such detectable features are present. Threshold tests can be used to decide whether the measure is sufficient for some purpose. What is needed not only is to detect that there are features present, but somehow to handle the presence of the features when assessing image quality, for example to determine and to indicate in a useful way whether an area of the image or the image as a whole is in focus.

There are a number of focus assessment image processing algorithms that can produce a measure of focus quality. In “Autofocusing in Computer Microscopy: Selecting the Optimal Focus Algorithm,” Y. Sun et al., Microscopy Research and Technique 65:139-149 (2004), the following algorithms are compared:

### Derivative Based Algorithms:

Thresholded Absolute Gradient (Santos et al., 1997)

Squared Gradient (Santos et al., 1997)

Brenner Gradient (Brenner et al., 1971)

Tenenbaum Gradient (Tenengrad) (Yeo et al., 1993, Krotov, 1987)

Sum of Modified Laplace (Nayar and Nakagawa, 1994)

Energy Laplace (Subbarao et al., 1993)

Wavelet Algorithm (Yang and Nelson, 2003)

Wavelet Algorithm W₂ (Yang and Nelson, 2003)

Wavelet Algorithm W₃ (Yang and Nelson, 2003)

### Statistical Algorithms:

Variance (Groen et al., 1985, Yeo et al., 1993)

Normalize Variance (Groen et al., 1985, Yeo et al., 1993)

AutoCorrelation (Vollath, 1987, 1988)

Standard Deviation-Based Correlation (Vollath, 1987, 1988)

### Histogram-Based Algorithms

Range Algorithm (Firestone et al., 1991)

Entropy Algorithm (Firestone et al., 1991)

### Intuitive Algorithms

Thresholded Content (Groen et al, 1985, Mendelsohn and Mayall, 1972)

Thresholded Pixel Count (Green et al., 1985)

Image Power (Santos et al., 1997)

Such focus algorithms can compare image quality characteristics but produce distinctly different values for different types of image content. A human can perceive tissue structures and similar features present in images. In instances where similar tissue structures can be found in two different images or tiles, the human might judge generally whether one or the other appears more focused by comparing the appearance of selected corresponding parts of the similar tissue structures. But what is needed is a way to make an automated assessment of image quality, especially focus, that automatically uses different quality standards to assess different regions in an image that have different types of content such as different tissue types and image textures, but does not require the processing time and sophistication that might be needed to recognize features in the image and characterize the tissue types.

What is needed is an automated and computationally efficient way to assist a pathologist in assessing the quality of digitized microscopic images, particularly as to the relative accuracy of focus, wherein the assessment accommodates different features appearing in the various images and different features in different areas of the same image. Such measures with respect to focus accuracy, for example, might comprise an assessment by summation of local derivative values of luminance or color component amplitude or saturation or another variable. Given two images of the same content at different focal distances, a higher sum of gradients may be a measure of better focus accuracy. In each case, a technique is needed to assess image quality when the content of the image is unknown and is variable.

U.S. publications 2008/0273788—Soenksen and 2008/0304722—Soenksen disclose efforts to automate quality assessments in connection with digital pathology imaging. Plural quality assessments are made, but the assessments involve prompting the user to subjectively rate the image according to a set of image characteristics. Several image aspects are rated and the image is accepted or rejected according to a pass/fail score on a composite value based on all the characteristics. In this method, good scores for one criterion or image area may balance bad scores for another criterion or area. The point is to give one score to the whole image.

2008/0137938—Zahniser discloses an autofocus technique. As mentioned above, objective contrast assessments can be used in autofocus systems for comparing contrast at one focal distance versus another to search for the best focal distance, but is not useful to compare images with different content because different image structures and textures (content) affect the assessment. Zahniser teaches using a dual contrast assessment at two different scales based on the Brenner algorithm, which substantially involves calculating an average of pixel value differences (e.g., luminance) between each pixel and its nearby pixels. In the original Brenner algorithm (Brenner et al., An Automated Microscope for Cytological Research, J. Histochem Cytochem 24, 100-111, 1971), a value is obtained by summing the squared difference for each pixel and its neighboring pixels two pixel positions away. Zahniser discloses providing Brenner scores at two different pixel spacings or pitches, namely one pixel position spacing and three pixel position spacing. An in-focus image has a higher Brenner score than an out-of-focus image of the same content. An objective in Zahniser is to estimate the focal distance that will produce the highest Brenner score to avoid time consuming trial and error. The ratio of the two Brenner scores in Zahniser is said to fall on a signature curve of ratio versus focal distance on either side of optimal distance. Matching three points on the curve allows one to find the focal distance along the curve with the highest Brenner score. The Zahniser technique is a refinement of autofocus techniques that involve comparing two or more images of the same content. Zahniser is not useful for comparing the focus quality of two images with different content or for comparing the focus quality at different local areas within the same image.

### SUMMARY

It is an aspect of the present disclosure that at least two objective image content analyses are applied to an image and used for different purposes. These two or more analyses can be contrast assessment algorithms for assessment of focus accuracy or a different assessment of quality. The two or more analyses can use different algorithms or the same algorithm. If the same algorithm is used, it optionally can be used with the same or different scale, orientation and/or other factors.

The results of one analysis or algorithm are used to segment the image into zones, sorting for groups of nearby pixels of blocks of pixels that produce comparable results by that analysis. The results of one or more analyses or algorithms (the same analysis/algorithm or a different one) are considered for the segmented zones separately, for example using acceptance criteria having threshold levels that are distinctly associated with those zones where the pixels were found to have comparable characteristics of contrast or another measure, preferably of image quality. The analyses can be applied in any order but are used respectively for separation of pixels into zones, and for assessment, namely for rating the quality of the pixels zone by zone.

In one embodiment, an algorithm responsive to image structure (e.g., shapes or texture) is applied as a step to produce a first set of values that correlate with a structural characteristic of the image content. This algorithm optionally might correlate to some extent with image quality but is used for segmentation into zones. The resulting values are analyzed and the pixels or groups of adjacent pixels that produced similar values within a predetermined range are associated with one another to define distinct zones. The zones advantageously encompass contiguous pixels and typically correspond to a given local tissue structure.

In one example, the pixels are associated as blocks of adjacent pixels, for example of 50 by 50 pixels. These blocks are discriminated into groups of blocks wherein an algorithm that is responsive to one or more structural feature criteria has produced values that are comparable, i.e., the results from the algorithm are similar within some predetermined tolerance, for the blocks in the group. The groups of blocks with comparable results often are blocks that are adjacent to one another because distinct tissue structure types typically extend over an area of the image encompassing plural blocks. But comparable zones also can occur wherein blocks with comparable results are discontinuously located, e.g., in a polka-dot pattern. It is not necessary according to this technique to recognize the tissue features in the image, such as cell boundaries or the like. The technique distinguishes and segments by zones of blocks in which the tissue type is similar, because the algorithm generated similar objective results, and not necessarily because the tissue type is the same.

The segmentation and association of blocks as described also accommodates the presence of tissue features that are discontinuous on a scale that is smaller than the blocks. For example, nuclei of cells may appear smaller than pixel blocks defined for an image of a given magnification. An assessment algorithm such as integrated pixel-to-pixel contrast responds to the presence of discontinuities such as nuclei. When defining zones of blocks that produced similar results (whether average values or variance or the like), the zones are areas within which image content can be compared objectively. In the example of nuclei, the segmentation divides the image into zones wherein the blocks have different densities of nuclei. Similar results are obtained with other tissue features.

A second algorithm is applied to the pixels (which can be accomplished before or after the first algorithm) to produce set of values that vary with a measure of image quality, such as a Brenner gradient to assess contrast and focus quality. Different acceptance measures according to the second algorithm are applied within the respective zones that were distinguished for comparable results under the first algorithm. Criteria for assessing the focus quality of the image are applied separately for each of the zones. For example, a statistical analysis or threshold test applied within a zone finds the local areas that are better or worse than other areas within the zone. Different pass/fail focus scoring acceptance thresholds likewise can be applied.

It is an object of the present disclosure to provide a numerical analysis technique to produce a map or similar spatially specific indication of local image quality over the area of an image. In one embodiment, a shaded or color coded map is generated, corresponding to the outlines of the specimen image, and arranged to indicate the image quality metric results, discriminated by zone. The presentation can be a color coded “heat map,” wherein alarm colors represent poor quality. The heat map can be displayed in conjunction with display of the specimen image, for reference to the quality assessment when reviewing the image.

It is also an object of the present disclosure to provide an assessment technique that is useful during the process of collecting images, to enable a pass/fail test. An image such as a microscopic sample image comprising one or many separately captured frames can be analyzed for quality by a programmed processor while still mounted for imaging. If the assessment concludes that some predetermined number or proportion of frames or zones or blocks or pixels is not acceptable, then the affected frames or the entire specimen is imaged again. The assessment and pass/fail process can be repeated until an acceptable specimen image has been collected.

The image in question could contain an array of stitched together image tiles, or could contain a single image encompassing an area. According to one aspect, the image is assessed for image quality at each pixel position or for grouped adjacent pixel positions. This assessment can be accomplished using a differential or statistical or similar transform to measure quality. An example is an assessment of the type used for comparing images of the same content at different focal lengths, such as in an autofocus technique. The quality measure transform produces an array of values, for points distributed over the image, where different features and different image contents may appear. The quality measure can be applied over the whole image, or at least to a test area such as the area occupied by the sample the image of a microscopic slide. The quality measure assessment encompasses varying features. As discussed in the background above, assessments from objective transforms produce values that may vary with a quality attribute such as focus quality, but also vary inherently with image content, i.e., the presence of different sorts of features appearing in the image.

The image is assessed according to at least one additional measure that will be used concurrently with the image quality assessment. The additional measure is also produced by applying an image transform to provide values that vary over the area of the image. However, the additional measure is chosen to produce an array of values, for points distributed over the image, that distinguish zones in which the image content has similar characteristics.

In one embodiment, at least one transform correlates with quality and at least one other transform correlates with differences in structure. In certain embodiments, two transforms are used that both correlate at least somewhat with quality and also with image structural content. In one embodiment, the two transforms are different in that one or more of the nature of the transform algorithm, the scale, weighting, granularity and similar specifics, and one transform is used to distinguish among zones as a function of image structure and the other is used to discriminate for quality within the zones. In another embodiment, after subdividing the pixels into blocks, the blocks are divided into zones discriminated because the blocks in each zone produced similar values using one objective algorithm. Different quality acceptance criteria are established for the respective zones. The acceptance criteria can apply to the results of the same algorithm used to segment the image into zones of similarly-valued blocks, or the acceptance criteria can be applied to the results of a different algorithm or to a distinct application of the same algorithm (e.g., with a different scale or orientation or pixel pitch or other particular). The acceptance criteria can be absolute or relative, and can be applied to the pixel data to obtain pass/fail or graded results for complete blocks or for pixel positions or groups of adjacent pixel positions.

Applicable measures to distinguish among different types of feature structure can include the Laplacian function for obtaining a second derivative value in perpendicular axes or a scale variant or scale invariant detector of a selected feature attribute, such as a blob detector or corner detector or a closed figure detector. One or more such transforms can be applied to produce transform values from the values of pixels or groups of neighboring pixels in the image. Advantageously, at least one algorithm or transform is sensitive to differences in structure and tissue type; at least one algorithm or transform is sensitive to image quality. The structure/type algorithm or transform(s) need not be applied so rigorously as to determine that the identical same tissue type in fact appears at two or more areas of the image. But distinguishing by structural characteristics has been found effective as a technique for associating together and also for distinguishing among areas of the image that are expected to produce similar image quality values using the algorithm/transform that is sensitive to quality, whereby a quality assessment is made possible without the complication of differences in image structural content.

The results transform that is sensitive to structure/type are used to classify the image into spatially distinct zones that produced different values (including different feature structure types). A distribution of transform results (values) is collected for pixels or neighboring grouped pixels or adjacent pixel blocks. The distribution can be divided linearly or statistically into ranges of values. Pixels or groups or blocks of pixels that fall into the different ranges are defined as zones of potentially distinct structural types. (It is not necessary that they actually be the same tissue types.) The results of a quality dependent transform are then analyzed on a zone-by-zone basis. Different grading or pass/fail criteria can be applied for the different zones to rate whether or not pixels or groups or blocks are of sufficient quality, especially to rate how precisely the pixels or groups or blocks are in focus, using a measure of quality (focus) that applies to the areas that were distinguished from one another by structure, using the additional transform as described. The grading or pass/fail results are tabulated or displayed or employed in a decision process that can result in all or part of a slide or composite image being rejected and queued for reimaging.

The quality assessments can be graded into some number of grades of quality as opposed to only pass/fail grades. The grades can be converted into a color mapping, for example showing the highest quality areas using a distinct color (e.g., peaceful colors for green or blue for best quality) and the lowest quality areas with another color (e.g., warning colors of red or orange). The colors are used to populate a silhouette version of the original image that can be displayed in conjunction with the display of the image to the pathologist, e.g., alongside or in a miniature inset or by a selectable mouse click operation with the zones grades shown by coloring or shading. A color or shade also can be superimposed on the image in one or more display modes of the image, for a quick reference to the quality grading assessment reached by the programmed system that processes and analyzes the pixel data.

In this way, a focus quality assessment is produced, relatively free of confusion associated with differences in types of tissue structure, that can be displayed on or in conjunction with display of the digital image or used to assess whether a slide or part of a slide will be reimaged in an effort to achieve better results.

### BRIEF DESCRIPTION

The following is a discussion of examples, certain alternatives and embodiments of the systems and methods disclosed as novel ways to address the objects and aspects discussed above. The invention is not limited to the embodiments that are shown or described as examples and is capable of variations within the scope of the appended claims. In the drawings,

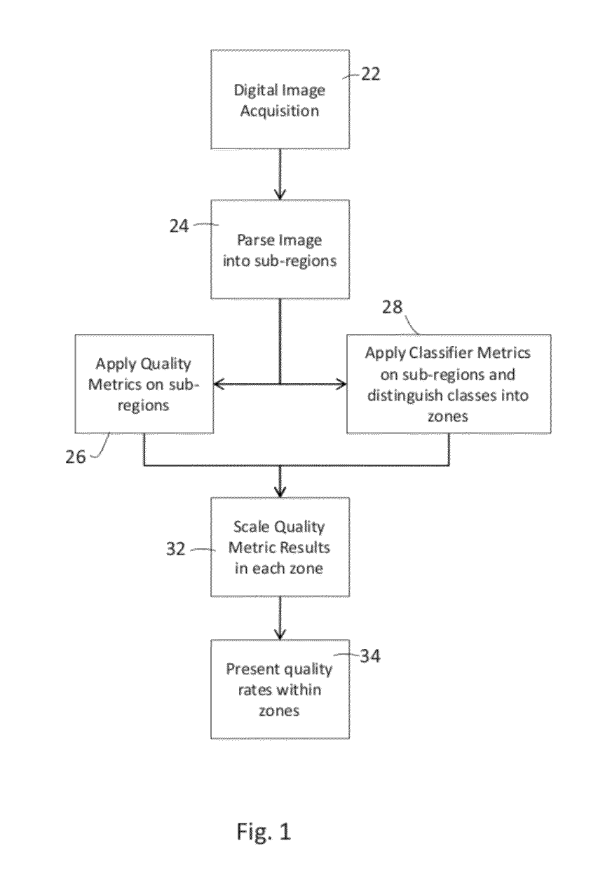

FIG. 1 is a block diagram showing general steps undertaken according an embodiment of the present disclosure.

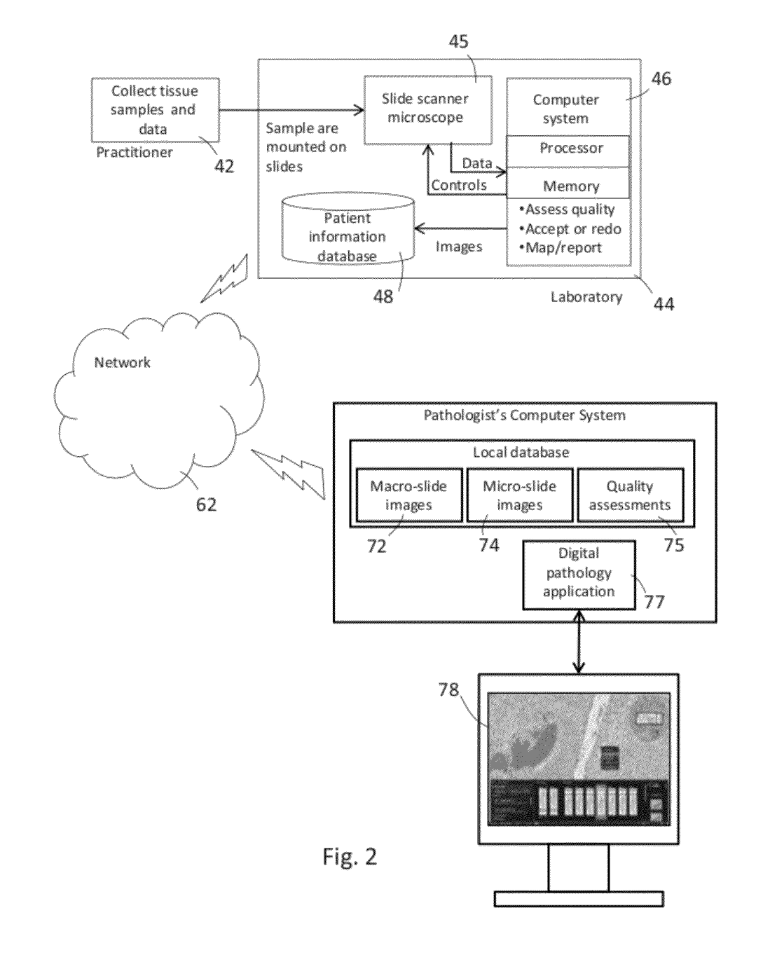

FIG. 2 is a block diagram illustrating aspects of a digital pathology system according to the present disclosure.

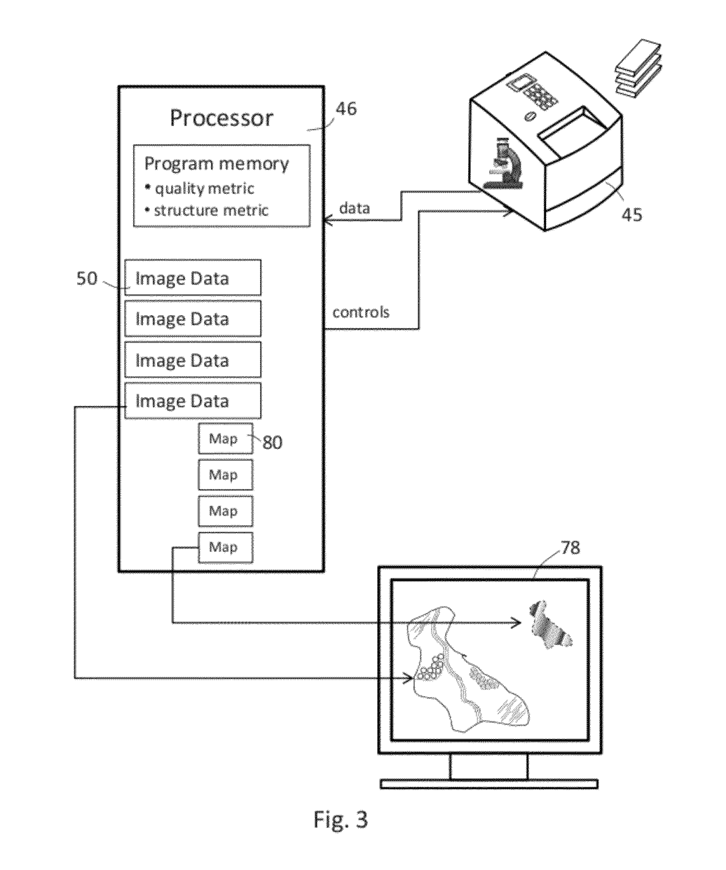

FIG. 3 is a system block diagram illustrating a system having a microscopic slide scanner with an associated control and image processing system coupled to a display.

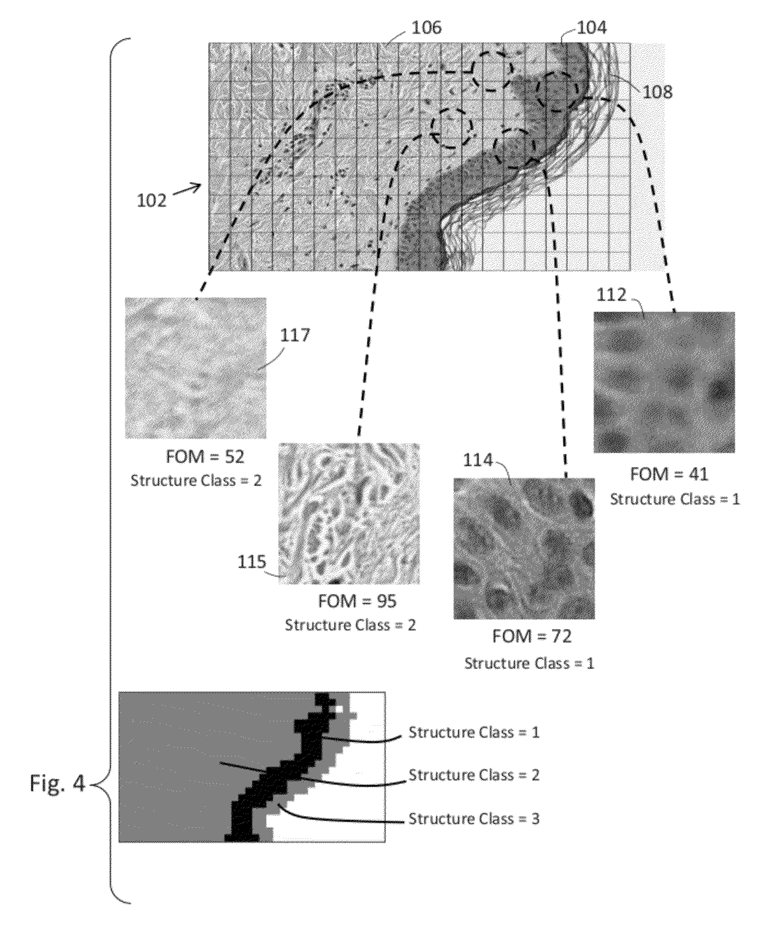

FIG. 4 illustrates a microscopic image divided into sub-regions with different features and different levels of focus quality, and a structural classification map corresponding to the microscopic image.

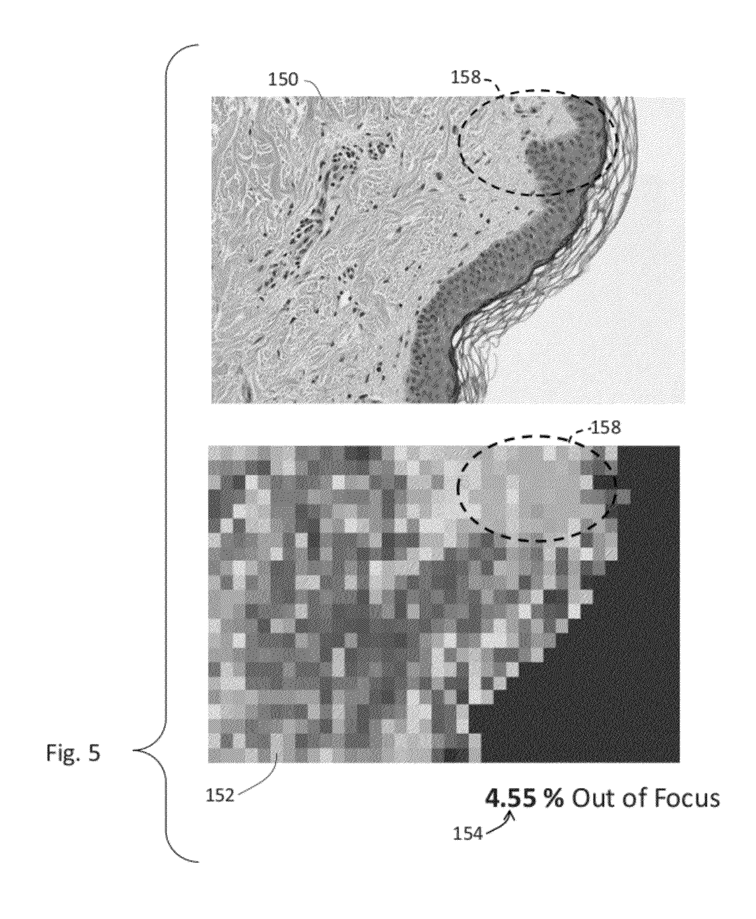

FIG. 5 illustrates a test area of the microscopic image and a corresponding grading of image quality (specifically focus accuracy) as rated for distinct structural class zones in a shaded block “heat map” and summarized numerically for the test area.

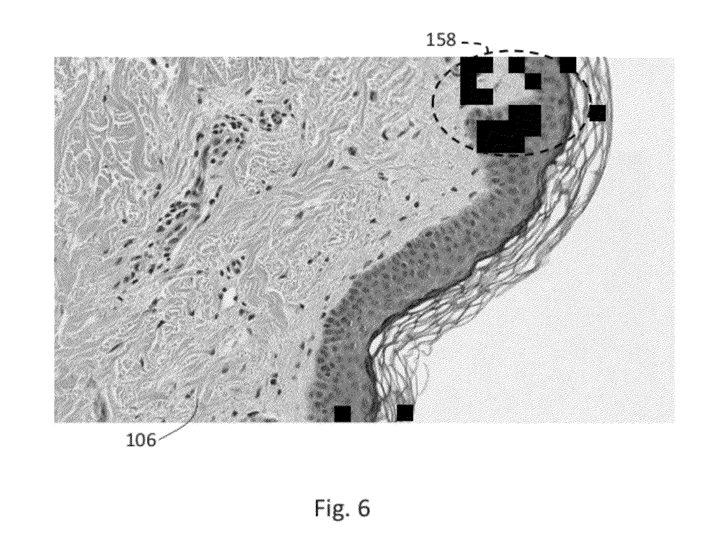

FIG. 6 is an overlay wherein sub-region blocks graded for image quality below a threshold are marked.

### DETAILED DESCRIPTION

According to the present disclosure, the quality of a digital image, especially the focus quality for a microscopic pathology sample, is assessed for sub-regions of the image using different quality assessment criteria in respective zones that have been distinguished by a mathematical classification that is at least partly correlated with image content structures, i.e., with the nature of features that are visible. Classification of the image into zones according to a structural classification permits the application of different mathematical standards in different zones for determining the pixel data characteristics that will be considered to represent high quality versus low quality. This assessment can be accomplished without requiring a reference image or alternative image against which the digital image is compared. The structural classification subdivides the image into zones of typically contiguous pixels associated by having a similar image structure, and as a result, a no-reference assessment comparing the pixels in the zones is made possible using an objective algorithm correlating with quality, such as a Brenner gradient to measure contrast.

In one embodiment, a digital microscopy system with a slide scanner having a digital camera and automatic focus control produces microscopic pixel data files containing digital images of tissue samples, for presentation on a digital display. A processor is programmed to generate from the pixel data file an image assessment map having sub-regions corresponding in position to sub-regions in the corresponding image. A display coupled to the processor can optionally present the digital images together with corresponding image assessment maps, which can be color coded to show where areas were assessed in the range of quality values. Alternatively or in addition, the image assessments can be used during image collection processes to decide whether to accept an image or a part of the image, or instead to attempt to collect better results by re-imaging all or part of a tissue sample slide. Display of image assessment maps visibly represents local focus quality over a range, and the image assessment maps apply different focus quality assessment criteria, on a zone-by-zone basis to zones that are distinguished by similarities and differences in features appearing in the zones, treated as distinct structure classes.

According to certain embodiments, a pixel data image processor is programmed numerically to analyze pixel values in at least a test area of an image according to a measure that correlates with focus quality and numerically to analyze the pixel values according to a measure that correlates with one or more structural characteristics. These can be two distinct measures such as a feature sensitive transform and a quality sensitive transform. The two measures also can be applications of a single transform that correlates with both structure and quality, but wherein two distinct steps are used, first logically to divide the test area into spatial sub-regions wherein groups of locally adjacent pixels that have similar characteristic values and are associated together as zones. Then in another step the processor determines a focus quality acceptance criteria that is distinct in each of the zones and is determined from a range of focus quality values found within sub-regions with similar structural characteristics.

The following discussion uses focus accuracy as an exemplary measure of image quality, which is apt for digital microscopy. Within the scope of this disclosure, other measures of image quality also may be considered, either separately or in conjunction with focus accuracy and optionally as a composite measure of image quality according to plural factors. Any of various measures of quality that have at least some correlation to the results of a mathematically applied test can be assessed and graded according to the disclosed techniques. Likewise, any of various mathematically applied tests with results that have at least some correlation with structural features in the image can be used to classify zones in the image into structural zones wherein different ranges or thresholds are applied to assess image quality.

FIG. 1 graphically illustrates the respective steps practiced with the system disclosed herein. A first step at block 22 is to obtain an image in the form of digital pixel data, i.e., numeric values for at least one amplitude corresponding to each point in an array of points over the image. The smallest discerned points, which could be determined by the layout of light responsive cells in an image sensor and/or by a sampling frequency in a scanning arrangement, are deemed pixels or picture elements. The amplitude can be a number that characterizes the luminance of the pixel to some digitized level between a minimum and a maximum. Preferably, the pixels are encoded in color, at least three variables being represented, such as red, green and blue amplitude (RGB) or luminance, saturation and hue angle (HSV), or luminance and color difference (YCbCr), etc. For purposes of illustration and without limitation, it can be assumed in an exemplary embodiment, that 24 bits are provided to encode three eight bit values for each pixel. The pixel data can be collected using a two dimensional charge coupled device (CCD) sensor exposed to an image for an exposure time, or a one dimension line sensor that is scanned perpendicular to its extension and sampled according to a sampling clock.

According to one embodiment, the image is a microscopic image of a pathology or histology sample to be examined by a pathologist. The image can be a high resolution image or a low resolution image. It is advantageous in a digital pathology system to provide both macro images of a sample and also micro images at higher resolution, with provisions to organize the high resolution images as adjacent areas or tiles and to enable the pathologist to navigate across the tiles when examining the images of the sample on a computer display screen. For this purpose, the image data can be processed to pan over adjacent image capture frames, to zoom in and out and for adjustments in orientation, color attributes and the like, to permit annotations, etc.

The images can be collected by an automated sample slide scanner having a stage position control and autofocus control as disclosed in U.S. Pat. No. 7,576,307—Yazdanfar et al., which has been incorporated herein by reference. In that embodiment, the sample is positioned or a position on the sample is selected using X-Y positioning actuators such that the image capture sensors are directed at a particular area that will be captures as a frame defining a tile or strip other shape. Two or more versions of the images can be compared using slightly different focal distances, for example using a Z positioning actuator to vary the distance between the optics and the sample. A pixel image data processor associated with the automated imaging system applies a focus assessment algorithm and compares the images, making adjustments to select the focal distance that achieves the highest focus accuracy, and the image is captured and digitized. In the case of mosaic tiled images, the respective tiles are mapped into a larger image space, merging overlapping margins if necessary. In any event, an image is acquired at step 22 comprising an array of pixel positions having numerically characterized visual attributes such as brightness and color.

The assessment technique according to the present disclosure can be a programmed process executed by the same processor used for autofocusing steps, but wherein the assessment is applied to the autofocused image after it has been acquired. The assessment technique can also be applied by a different processor that obtains access to the pixel data, such as a processor arranged to process and archive slide images in a histology/pathology workflow arrangement, and/or a processor associated with the image viewing apparatus used by a pathologist to view digitized microscopic images. It is advantageous, however, to execute the assessment technique in association with scanning the images from specimen slides, either using the same autofocus processor or a co-processor with access to the image data, because the assessment results then can be used to cause the imaging system to re-image all or part of the specimen slide while the slide is still mounted in the imaging system.

In exemplary embodiments, the automated slide scanner can comprise a microscope with an image exposed at 20× or 40× magnification on a CCD sensor element with 2048 by 2048 pixels in a 4 megapixel image embodiment, each pixel being encoded to 24 bits, such as 8 bits for R, G and B amplitudes. The resolution alternatively can be 8 megapixels or more. The image as recorded on the CCD sensor is to be further enlarged for display on the display screen, providing a total magnification of 200× or 400× or more.

Among other objectives, the present disclosure seeks to assess and indicate the quality of the image, not by comparing two alternative views of the same image, but to assess the quality of subdivided areas of the image using other areas of the image for comparison, i.e., to assess quality without a separate reference image. Referring again to FIG. 1, at step 24 the pixel image data, which has discrete image data values for points regularly placed across the image field, is divided into adjacent sub-regions, namely blocks of preferably regular size and shape positioned adjacent one another in a regular array (e.g., squares, rectangles, hexagons, etc.). In the example of 2048 by 2048 pixels in an image, square sub-regions of 50 by 50 pixels might be defined as pixel blocks to be processed as a unit. The number of pixels in the sub-regions is not critical except that the sub-regions advantageously are smaller than dimensions in the image where the sample typically has distinctly different tissue structures discernable. The size of the sub-regions optionally can be made selectable at the option of the user or as a system customization feature.

The pixel data for the captured image or images is stored in an addressable memory buffer. The pixel data values are obtained from the memory by addressing memory cells indexed to correspond to pixel positions in the image. The memory can be arranged so that data for laterally adjacent pixels is stored in successive memory addresses and vertically adjacent pixels are stored at addresses offset by the pixel count in a full line. This facilitates applying a matrix transform to the data value of a pixel and its adjacent pixels or neighboring pixels in the image. Where sub-regions abut, it may be necessary to take into consideration the values for pixels that are actually not in the same sub-region of the particular pixel but are in the adjacent sub-region. In this context, the term “neighboring” pixels encompasses pixels that are within some threshold of distance from a given pixel, possibly but not necessarily immediately adjacent, and includes arrangements based on interpolation (insertion of additional pixels) or decimation (removal of pixels) to provide pixel values based on other pixel values in the array of pixel values captured.

An image test area can be defined and divided into sub-regions of a predetermined number of adjacent pixels. The image test area can comprise all of the image or can be limited to a particular part of the image, such as the non-blank area on the image of a glass slide that is occupied by the sample. A algorithm or transform is applied to the test area and produces a numeric value that varies over some range, in a manner that correlates with the relative presence or prominence of image structural features and/or image quality. In one embodiment, the image metric is applied some or all of the pixel positions in each sub-region or block, to obtain one or more output values that characterize the pixel data in the respective sub-region. The image metric can be any of various mathematical functions that have some correlation with structure and/or image quality. An advantageous category from the user's perspective in connection with digital pathology is the assessment of focus accuracy across the area of an image, by integrating the contrast found for pixels throughout the subregion. An assessment is made after segmenting the subregions into zones that produced comparable values within some tolerance, and defining acceptance criteria for each zone of associated similar subregions. This process can be accomplished using the results of one or more mathematical algorithms that produce values that are at least correlated with the accuracy of focus and may also be correlated with structural feature presence and prominence.

This disclosure is also applicable to a variety of assessment algorithms applicable to digital pathology, wherein there is a correlation between the results of the algorithm and image quality and/or structure. The disclosure is also applicable to quality assessments that may have some relationship to other fields of use for images being assessed. Examples are spatial frequency response for fingerprint images, image power spectrum for random scene images, mean square error for images that have been digitally compressed and recovered, etc. For purposes of illustration, this discussion will be substantially directed to focus accuracy (image sharpness) as a nonlimiting but exemplary characteristic that represents image quality.

There are a number of algorithms with results that correlate with focus quality. Examples are mentioned in “Autofocusing in Computer Microscopy: Selecting the Optimal Focus Algorithm,” Y. Sun et al., Microscopy Research and Technique 65:139-149 (2004), cited and incorporated above. A complication is presented, however. The results of a focus quality algorithm vary with the content of the image as well as with the accuracy of focus. The algorithm does not discern whether variation of the measured parameter (such as average contrast) is due to local differences in image content or due to focus variations. Such an algorithm cannot produce a meaningful value to provide an objective absolute measure of focus accuracy, although it can be operated in a relative or comparative way by comparing a subject image against a reference image at a different focal distance, showing the very same content. If the content depicts a scene with numerous contrasting edges, even with relatively poor focus accuracy, mathematical algorithms for assessing focus quality may produce an absolute grading that is higher than the same algorithm produces for a scene with few contrasting edges, even in very good focus.

Referring to the example in FIG. 1, after obtaining a digital image (step 22), preferably storing the image data, and defining sub-regions of neighboring or abutting pixels (step 24), two algorithms are applied at steps 26, 28, to develop two assessments that are respectively associated with a measure of quality and a classification of a structural aspect such as texture, for example. In FIG. 1, at step 26 a focus quality assessment algorithm is applied to the pixels in the test area as described. At step 28 a structural classifier algorithm is applied to the test area. FIG. 1 illustrates steps 26, 28 as parallel paths; however generation of a focus quality assessment and a structural classifier assessment could be accomplished at the same time or in any order, e.g., successively.

The quality algorithm used at step 26 can include one or more measures of quality. An example is a measure of local focus quality obtained by calculating local contrast between neighboring pixel values, integrated over an area, such as a Brenner gradient or another measure that correlates with image focus quality. As discussed above, that measure also varies with the content of the image.

However, the classifier algorithm is used to sort the pixel data into zones that have similar content shown. The classifier algorithm (step 28) can be selected for having at least some correlation with variations in the structural appearance of features that appear in the image, such as lines, edges, periodicity and other features that are visible and tend to distinguish among different tissue types. The numeric results of the classifier algorithm are assessed separately for each of the sub-regions into which the test area of the image was divided at step 24. A sub-region characterized by a feature population that is similar to the feature population of a different sub-region produces similar values from the classifier algorithm. Examples of classifier algorithms are scale sensitive and scale insensitive detectors of shapes such as blobs, circles, corners, lines or curves, as well as periodicity, alignment, density, etc., namely visible traits that are mathematically detectable by applying mathematical functions to pixel values and the values of their neighboring pixels.

Having determined results of the classifier algorithm at step 28 for each of the sub-regions, the values for all the sub-regions can be used to sort the sub-regions into structural classes. The classification can be done based on a linear division of the span between the maximum and minimum extremes that the classifier algorithm produced for all the sub-regions. Alternatively, a statistical measure can be applied to assess whether the results fall into distinct groups (e.g., peaks in a population histogram) for treating the groups as different classes. By one or more such methods, the span of classifier algorithm results is divided into two or more ranges of values. The image sub-regions that produced classifier algorithm results falling in the same classification range are considered, tentatively, to contain the same sorts of image content. The image is then spatially distinguished into sets of two or more grouped sub-regions (which typically are adjacent) and have produced approximately equal structural classification values. These distinguished regions are distinct zones according to this disclosure, where different high, low, mean and other sorts of values resulted from the algorithm used as the classifier. It is an aspect that different standards for acceptance and rejection in the distinct zones are likewise to be used to assess the results of the algorithm used for quality assessment.

In the zones where blocks of pixels had approximately equal structural classification values, the image quality assessment values are analyzed separately for that given zone, independent of the analysis of other zones that have been distinguished due to having structural classification values that are distinctly different from the values for the given zone. Image quality analysis can include applying selection criteria based on thresholds or statistical spreads, for identifying, zone by zone, the pixels or blocks of pixels that have relatively higher or lower image quality. The criteria for deciding whether the focus accuracy or other image quality measure is good or bad at a given pixel position (or for a given block of pixels defining a sub-region), are determined based on whether that sub-region is a member of one classification zone or another.

The pixels or sub-regions that are sorted into a zone typically have similar structural traits, but it is the similarity of classifier algorithm results that distinguishes the zones. It is possible but not necessary to recognize structural traits as a part of the process. At step 32 in FIG. 1, the image quality algorithm results for all the sub-regions that after sorting were classified in the same zone are analyzed and scaled for that specific zone, producing a range of quality values. The sub-regions having quality values at the ends of the range encountered within the zone are graded as having relatively high and low image quality. After this has been accomplished for all the distinct zones, the quality rating for the test image is reported at step 34. The quality rate can be reported using a threshold of acceptability and giving a ratio of the number of sub-regions that fail, thereby assessing the whole test image. Alternatively, the quality of the sub-regions can be reported by graphically mapping the quality assessment results of the respective sub-regions, either in a threshold pass/fail map or in a graded assessment using colors for high quality, low quality and one or more intermediate levels. Advantageously, a “heat map” is generated wherein the colors applied to positions on a map corresponding spatially to the image are chosen to represent the zone-specific quality assessments of the pixels or pixel blocks. Advantageously, if the assessment is computed in conjunction with image collection, a decision can be made to reacquire images of the entire subject or of a selected area.

In an important application, the foregoing techniques are applied to a digital pathology system. FIGS. 2 and 3 generally illustrate how a digital pathology system can be configured. Referring to FIG. 2, a practitioner at block 42 collects a sample from a patient, for example in a procedure involving a biopsy or cytological harvesting of tissue or cells or fluids for pathological analysis. The collected sample is sent to a laboratory 44 at which histological operations are undertaken. The sample is blocked and sectioned and chemically preserved, during which one or more stains is introduced. The sectioned tissue samples are mounted on glass slides, covered with slips and marked for identification. The slides are imaged using a slide scanning microscope 45, for example having a magazine and feeder for accepting racks of slides containing slides for one or more patients. The slide scanner is operated in conjunction with a computer processor 46 that can be housed as part of the slide scanner or can be a separate computer that is coupled to the slide scanner. In any event, the processor 46 supplies certain control signals to the scanner and a digital camera or scanning sensor provides pixel date to the processor. Processor 46 and/or other associated processors are provided with access to the pixel data, stored in memory, and are programmed to execute the processing steps defined herein.

In an autofocus arrangement as in U.S. Pat. No. 7,576,307—Yazdanfar et al., one function of the processor is to assist in adjusting the focal distance of the sample from the camera optics. In that arrangement, two cameras capture images at different focal distances at the same time, which is quick, or one camera can be used to capture successive images at different focal distances. In any case, the focus quality of two or more alternative images is compared to establish the focal distance that produces a well focused image, which image is permanently captured. This may involve selecting among two or three images at different distances for the one with the greatest amount of contrast, integrated over all the pixels, which is considered to represent the image with the best focus. Advantageous, rather than selecting among two or more available candidate images, by numerically analyzing the pixel data of the available images to estimate an optimal focal distance, it is possible to adjust the optics to seek an optimal distance whereupon an image is captured.

Many images may be collected at differing magnification, or a set of images at the highest magnification is collected and when necessary processed by image display techniques to zoom out to lower magnification views. The digital image data 50 and associated information are stored in a database 48. The data is made available to a pathologist, who can be located at another facility and in data communications with database 48 over a network 62.

The pathologist operates a computer system 64 wherein macro-slide images 72 and micro-slide images (such as individual high magnification image tiles) are stored at least temporarily for viewing under control of a digital pathology application program 77 on a computer display 78. The application program enables the pathologist to select among alternative presentations of images at different magnification, to pan and zoom the displayed image to selected places over the overall image field, to review all parts of the image field, and to enter data relevant to the images and the patient. In an advantageous embodiment, the pathologist can pan over the image field and zoom in and out using keyboard input or pointer devices (such as a computer mouse or joystick controller).

Among other information presented to the pathologist is the result of the image quality assessment discussed above. Quality assessment data 75 can be generated by the pathologist computer system 64 as part of the application program 77. Alternatively and as shown in FIG. 3, the quality assessment information can include a focus quality map that was generated from each image or from selected images by the processor 46 associated with the scanner microscope and stored as a focus quality map 80 that is stored in the patient database 48 together with the images 50 and made available over the network to the pathologist system 64.

FIGS. 4-6 illustrate results produced according to a practical application of the foregoing techniques to focus assessment of a tissue sample, in particular a sample of skin tissue. The tissue sample has been prepared, e.g., blocked, sliced, preserved, stained, placed on a slide, covered with a slip and photographically captured as a digital image. The image 102 depicts a slice of tissue with distinct regions having structurally distinct traits. The derma 104 in this example is characterized by the appearance of cells showing as lozenge shapes having darker centers within lighter ovals. The stroma 106 under the derma is characterized by light swirls in a generally even field, but for areas at which dark spots are concentrated. The outer surface portion 108 appears as a mat of lines or fibers.

In the example shown in FIG. 4, it can be seen that the focus quality is uneven across the image area. This could be due, for example, to a variation in the elevation of the surface of the sample, causing part of the surface to reside above or below the precisely correct focal plane when the image was collected. It is an object of the present disclosure to meaningfully assess the quality of the image, in particular the focus accuracy, while dealing with the fact that the image has different feature structures in different areas. An application of an algorithm that produces a value that correlates with focus accuracy is likely also to correlate to differences in the extent to which structural features shown in the image, i.e., traits of the imaged tissue sample, have distinctly delineated lines or shapes.

In FIG. 4, four sub-regions 112, 114, 115, 117 in have been selected for comparison, their positions being indicated with broken line circles. The content of these sub-regions is shown enlarged, evidencing differences in feature content and also differences in focus quality among the blocks. Blocks 112 and 114 are from the derma part of the image primarily containing visible cell structures. Blocks 115 and 117 are from the stroma part of the sample and might be described as having light ropy lines on a pastel background and some concentrations of dark spots. These particular features are partly the result of staining the sample to reveal biological information by increasing the light/dark contrast between some biological elements.

In addition to differences in structural type, a comparison of blocks 112, 114 from the derma suggests that the blocks have similar content but block 114 seems to be in clearer focus than block 112. Likewise, from the stroma, block 115 seems to be in clearer focus than block 117. The difference in focus can be revealed by application of a focus quality algorithm. As mentioned above, there are various algorithms for detection of focus quality. For purposes of discussion, the Brenner Gradient algorithm is used as an example, although other focus assessment metrics are applicable as well. The Brenner Gradient algorithm computes the sum for all pixels of the first difference between a pixel value i(x, y) and the corresponding pixel value of a neighboring pixel with a horizontal distance of two pixel positions. That is:

$${F}_{Brenner} = {\sum }_{Height} {\sum }_{Width} {( i ( x + 2 , y ) - i ( x , y ) )}^{2}$$

where ((i(x+2, y)−i(x, y))²≧θ (namely when the difference exceeds a threshold). This equation has a horizontal orientation but can be executed using a vertical or other orientation. The equation also can be executed using a pixel spacing other than two. The pixel value “i” can be a luminance or color-based variable value for the pixel such as the sum or average of R, G and B amplitudes. For comparing two blocks as in FIG. 4, the sum is accumulated for all the pixel positions in the block. This algorithm as applied to blocks 112, 114, 115, 117 in FIG. 4 produces the values labeled FOM. It can be seen that block 114 scored higher than block 112 and block 115 scored higher than block 117. However the quality of focus is high in both blocks 114 and 115, but block 115 scored much higher in focus quality by this metric. In practical language, the differences in image content apart from focus quality reduce the effectiveness of the algorithm to detect focus quality.

According to an advantageous embodiment, the image is subdivided into zones by a structural classification algorithm. Those zones that have similar structural shape characteristics in the content, as discriminated by a structural classification algorithm without attempting to recognize specific features in the content of the image, form subsets wherein the focus quality metric is applied locally, using scaling and acceptance criteria that apply only to the zone.

A useful image structure classifier is the Laplacian operator, which sums the second derivative of pixel values in the X and Y spatial directions. The general function for a pixel position f(x, y) can be expressed:

$$Δ f = \frac{{\partial }^{2} f}{\partial {x}^{2}} + \frac{{\partial }^{2} f}{\partial {y}^{2}}$$

A practical application of this technique is to convolve the pixel values by multiplying each pixel value and the values of its neighbors by a convolution matrix having respective factors that are chosen to reveal the second derivative, for example using the convolution mask:

$$L = \begin{matrix}- 1 & - 4 & - 1 \\ - 4 & 20 & - 4 \\ - 1 & - 4 & - 1\end{matrix}$$

To compute the second derivative C(x, y) for the respective pixels. These values are summed or averaged for all the pixel positions within the respective sub-region, providing:

$${{F}_{Laplace} = {\sum }_{Height} {\sum }_{Width} C ( x , y ) )}^{2}$$

The Laplacian algorithm correlates with differences in the structure or visible traits in the content of images and can be used to classify areas in the image content as belonging to one structural class or another because the areas produce similar values using the Laplacian algorithm. Areas of the image that produce similar values for these Laplacian sums are likely to contain similar structural elements.

According to an aspect of this technique, the structural classifier need not attempt to discern what particular structural elements or traits are present or to recognize traits or features. Instead the results are used to group together areas for separate assessment of the image quality metric. The image is parsed into zones of sub-regions or blocks of neighboring pixels (such as the grid blocks shown in FIG. 4) that produce similar results from one of the algorithms. Specifically, the sub-regions or blocks are determined, namely discrete X and Y ranges of pixel positions. The focus quality metric and the structural classifier metric are applied to all or at least a representative sampling of the pixel positions in each block. The sub-regions are sorted into zones, such as contiguous groups of sub-region blocks, that fall into the same parts of a range of structural classifier output values. These zones are treated as independent areas, subject to acceptance or grading criteria that apply only within their respective zone. The acceptance criteria can be arranged to identify values that are outliers after statistical analysis or otherwise to discriminate against places where the quality, such as the accuracy of focus, are relatively poorer than other places, but using comparisons of quality only within the zone.

Each of the zones is processed in this way using criteria that are specific to that zone. After all the zones are processed, a map corresponding to the image can be marked, for example with color coding, to show variations in focus quality. Alternatively or in addition to mapping and displaying results, the results can be used to make pass/fail assessments for image frames that include parts of the zones, or for entire images containing plural frames. Failing assessments can cause images to be rejected and re-imaging steps are accomplished as necessary.

Due to the disclosed technique of separately classifying and grading structurally distinguished zones, the result is an image quality map or an image quality assessment (especially for focus accuracy) that is relatively free of the complicating effect of variations in image structure on assessment of image quality. No separate reference image of the same image content is required for comparison with the image being graded.

In FIG. 4, the image or at least a test area has been subdivided into sub-regions such as blocks in a grid as shown. The resulting values for the structural classifier metric are summed for each block. The set of structural classification values for all of the blocks are a population with a maximum and minimum value, a mean, an average and standard deviation, etc. The population is divided using these statistics into a plurality of image structure classifications. In FIG. 4, three structural classes were distinguished by equally dividing the span between the maximum and minimum classification metric sums into three equal spans. An alternative is to analyze the population statistically and, for example, to count and subdivide classes between histogram peaks in the population, possibly identifying a larger or smaller number of distinct structural classes present.

By subdividing the sub-regions into two or more classes, a corresponding set of separate pixel populations are obtained that produced similar results based on visible traits, i.e., image content structure. Typically, the structure classifications tend to divide the test area into zones wherein adjacent blocks are in the same classes (although it is possible that the blocks could be more randomly positioned). In FIG. 4, it can be seen that the structural classes produced correspond with zones that a human might distinguish subjectively as different tissue types. However, the results are the output of the structural classification algorithm, namely an objective numeric conclusion based on the output of an algorithm that correlates with structural variations, such as the Laplacian function.

As discussed, the Laplacian function can be characterized as a two dimensional second derivative. Such a function also correlates to some extent with focus accuracy. Therefore in another embodiment, the Laplacian function could be used as a focus quality metric, and a different function would be used to distinguish structural classes, such as a blob detection algorithm or an algorithm sensitive to spatial periodicity. Structural classifiers can include known affine transformations, blob detection algorithms, edge or corner or other feature detection, spatial period evaluations and other analyses. The particular operation can include mathematical operations involving abutting or neighboring pixel positions such as convolution masks and matrices of factors. The operation can be accomplished with or without scaling for more or less strongly detect features of particular length or height or both, measured by pixel positions and/or varied with different magnifications.

The use of Brenner Gradients and Laplacian functions representing quality and structural segmentation algorithms, respectively, are useful but are not limiting. Both of these algorithms correlate with both quality and structural distinctions. The present technique is useful because at least one algorithm is used for the purpose of segmenting the blocks of the image into different zones of image types, and at least one algorithm is used for the purpose of assessing the quality within each zone, at least substantially independently of the assessments used to assess the quality in other zones. Assessments that can be used include absolute or differential values that will be deemed acceptable maximum, minimum, mean, variance, etc. Other criteria can also be examined. The same algorithm, or the same algorithm using different factors or orientation, or different algorithms, can be used for these two purposes.

In each case, at least two metrics are applied, of which at least one correlates to at least some extent with image quality (especially focus accuracy) and at least one other correlates at least to some extent with structural classification, i.e., visible traits. The two metrics can include the results of the same sort of algorithm if that algorithm correlates with both structural variations and focus accuracy (such as contrast assessments). In a case where the same algorithm is used for structure classification and also for quality assessment, it is advantageous to vary an aspect of the algorithm when used respectively to assess structure and quality. Variations can include changing the orientation or scale of a contrast assessment such as a Brenner gradient calculation, changing factors of a convolution matrix such as a Laplacian matrix, etc. Although these arrangements are workable, embodiments are particularly advantageous when using an algorithm for structural classification that correlates strongly with structural variation, such as the Laplacian transform, and an algorithm for quality assessment that correlates strongly with quality, such as a Brenner algorithm that assesses contrast and bases assessment of focus quality on integrated total contrast.

Using the structural classification results as a measurement, sub-regions with comparable structural classification results are associated into structure class zones, an example being shown in FIG. 4. Then, by separately considering the sub-regions belonging to each respective structure class, the pixel quality values for the sub-regions in the classes are used to develop separate grading or acceptance criteria that will apply only to the sub-regions within that structure class. In the case of FIG. 4, three sets of image quality criteria are generated and applied to assess the focus quality for the sub-regions within the respective zones. As shown in FIG. 4 by shading, the sub-regions in the respective classes define zones of the image.

The focus quality criteria applied for the structure classified zones can be graded on a curve, e.g., scaled such that the best quality pixel in a given zone is scaled to 100 and the worst quality pixel in that zone is scaled to zero, with ranges between these extremes being considered of higher or lower quality by comparison. It is also possible to analyze the population of pixel quality values in zones using statistical measures such as average and standard deviation, and to discriminate statistically for outliers that may represent focus quality problems. However, these analyses are done within spatial zones discriminated for structural attributes using an objective algorithm. As a result, the quality of the entire image can be meaningfully assessed without the complication of different structural types producing different quality assessment values (e.g., average local contrast) that precludes a direct comparison.

The focus quality scores can be reported numerically, and/or summarized, and/or applied to a pass/fail test for the image or for particular sub-regions, and/or used to produce a color or shading coded focus quality map that permits the quality of the focus in the sub-regions to be compared, or used to queue images portions or complete images for a new image capture attempt. Referring to FIG. 5, for example, the image 150 can be displayed in conjunction with a mapped display 152 of zone-specific graded focus quality grades, of a size equal to the image 150 from which the mapped display was generated. The focus quality of the sub-regions (the blocks in image 152) can be shaded or color coded for ranges, for example as a “heat” map wherein a range of perceived warm colors (intense red or orange) and cool colors (pastel blue and green) delineate the range of focus quality over the area.

It is possible in a case where the focus quality is uniformly good or bad that the heat map or similar mapping shows an even dispersion of colors over the field. However in the example of FIG. 5, the heat map indication has an area 158 where there are a number of sub-region blocks found to score low in quality, including adjacent sub-regions that extend across the zones of structure classes 1 and 2 in FIG. 4. This situation informs the pathologist when reviewing the image that aspects of the sub-regions in that area of the image are suspect.

In FIG. 5, the heat map is shown in conjunction with the image. It is also possible as shown in FIG. 6 at least temporarily to superimpose shading or colors on sub-regions that are found to have an image quality characteristic such as quality on the low end of the scale for the structure zone. Normally, the point is to identify the image quality by objective measures, and not to obscure the sub-regions that have a lower level of focus accuracy or other measure of quality. It is then left to the pathologist to determine whether or not the tissue features in the low quality sub-regions are sufficiently important to justify requesting a new image of the sample.

Therefore, according to the respective embodiment of this disclosure, a method is provided for analyzing images 102 in digital format, wherein the images can contain features of varying sizes and shapes. The images are defined by pixel values such as luminance and color values in a range. The values are analyzed in at least a test area of an image according to a first measure, thereby obtaining first measurement values that vary across the test area. The pixel values also are analyzed in the test area according to at least a second measure. The second measure relates to a characteristic of the image that is at least partly independent of the first measure, and thus a set of second measurement values are obtained that vary across the test area. One of the two test measures, such as the resulting values from the second measurement, are useful to classify and segment the test area of the image into zones where different standards may be used in the zones to assess what levels of the first measurements will be deemed good or bad in those zones. The first measurement can be a measure correlated with focus accuracy. The second measure can be a measure correlated with feature structures of one type or another, discerned in the image. A particular algorithm may correlate to focus accuracy and structure, although it is advantageous to choose an algorithm strongly correlated to structure for the purpose of segmentation into zones, and an algorithm strongly correlated with quality, such as integrated contrast to assess focus, for pass/fail or incremental grading as to quality.

Accordingly, having divided the test area into spatial sub-regions that encompass groups of local pixels (seen as grid blocks in FIG. 4) and determining for each of the sub-regions a characteristic value of a first one of the first and second measurement values in each sub-region, such as the measure correlated with structural features, adjacent ones of the sub-regions are associated together because the characteristic values are found to be similar for those sub-regions. For example, the characteristic values of sub-regions that are associated together can fall within a predetermined threshold of difference. The sub-regions that are thereby associated define zones in the test area, shown as shaded structure class zones in FIG. 4.

For each of the zones, an acceptance criterion is defined that applies to the other one of the first and second measurement values, such as the focus accuracy or another quality metric. The acceptance criteria that is specific to each structural zone is used to rate the sub-regions in those zones according to the local zone-specific acceptance criteria in which the sub-regions are located. In some examples, either or both of the measures can correlate somewhat with quality metrics and/or with structural classifications. Advantageously, the two measures are different.

An advantageous measure of focus accuracy as the image quality metric specifically can involve one or another or combination of various types of mathematical assessments, listed above. A number of candidates are detailed and compared, for example, in “Autofocusing in Computer Microscopy: Selecting the Optimal Focus Algorithm,” Y. Sun et al., Microscopy Research and Technique 65:139-149 (2004), also cited above. Generally speaking, these are measurement techniques and algorithms including derivative-based algorithms, statistical algorithms, histogram-based algorithms and intuitive algorithms. An advantageous first measure includes determining a Brenner gradient for at least certain x, y pixel positions in a tissue area of a microscopic slide image, and preferably for all the pixel positions.

Advantageous categories for the second measure include structure similarity measurements such as affine transformation, blob detection, edge detection, corner detection, periodicity, convolution masking and scaling, and in one embodiment the second measure includes applying a Laplacian convolution matrix.

For presentation of information, an image map can be generated wherein quality and/or structural classification results summarize all the pixels or at least all the tested pixels in each of the sub-regions. The results are identified by color coding of spans in a range from the minimum to the maximum values. Although such results can be generated for all the sub-regions regardless of structural classification, the information is more meaningful when the results of the image quality metric are separately rated for distinct structural classification zones. In one embodiment, the member sub-regions of a classification zone are separately distinguished by their position in a range of results for that zone only. However the ratings, such as high-medium-low, or 10^{th} percentile, 20^{th} percentile, . . . can be indicated using the same colors. Inasmuch as the acceptance criteria are visibly represented using the same indicators such as colors, but the quality metric values differ for different structural classes, the result is that the same color indicator in different zones represents the relative quality within the zone independent of the absolute relative quality value across all the zones in the image.

The color indicators can be mapped to positions on an outline or copy of the image. That is, a copy of the image is generated wherein the image comprises colored blocks wherein the color corresponds to the zone-specific quality rating of the sub-regions and the block position is the relative position of the corresponding sub-region in the image. This color image can be displayed in conjunction with display of the image itself, enabling the pathologist or other viewer to compare particular places on the image data with the focus accuracy or other quality rating at the same position on the color block map. If the colors are arranged in an order from psychological colors of assurance such as blue or green ranging to colors of alarm such as red or orange, the color block map can be viewed as a “heat” map. Among other possibilities, the heat map can be shown alongside the image, in the same or a different scale, or selectively displayed in place of the image. One objective it to limn sub-regions of higher and lower focus accuracy. It is also possible to display results numerically.

The areas failing to meet pass-fail acceptance criteria can be specifically identified or mapped for a visual reporting of the quality assessment. Instead or in addition, the results of the pass-fail test can be used to trigger a re-imaging step. Re-imaging of individual frames can be selected if any portions of segmented zones fail to meet acceptance criteria. Alternatively, a frame could be queued for reimaging if some number or ratio of blocks in the frame fail the acceptance criterion within their zone. Re-imaging can be triggered for a frame when failures exceed some limit such at 5% or 10%, either in the whole image or in any given zone. The entire specimen can be queued for a new imaging step if some threshold of acceptance is not met. Advantageously, these assessments are made before the specimen slide has been demounted from the imaging apparatus and is conveniently available for re-imaging.

The subject invention entails both systems and methods for assessing images in digital format, wherein the images can contain features of varying sizes and shapes. The method includes analyzing pixel values in at least a test area of an image according to at least one measure associated with image quality, thereby obtaining quality values that vary across the test area. The test area is divided into spatial sub-regions that encompass groups of local pixels, and a quality measure is determined for the sub-regions that characterizes the quality values for all or some pixels found in the sub-regions. Pixel values in the test area are analyzed according to a measure associated with image structure, and thereby obtaining structure variable values that vary across the test area. Adjacent ones of the sub-regions in which the structure variable values are found to fall within a predetermined threshold of difference are associated together and regarded as zones having similar or at least comparable structural attributes. After determining a range of image quality values of the sub-regions within the zones, wherein the ranges can differ from zone to zone, the sub-regions in each zone are graded or similarly subjected to quality acceptance criteria, on a zone by zone basis. A preferred quality measure includes at least one measure of focus. The images can be microscopic digital images of samples for pathological analysis, imaged at the conclusion of histological preparation. In an advantageous embodiment, the quality measure includes a Brenner gradient such that the quality measure varies with accuracy of focus; and the structure variable includes a Laplacian transform such that the structure variable values distinguish associate and distinguish between zones by similarities and differences in depicted tissues.

Having scaled the results of the focus quality metric separately zones or similar subsets, and producing a range characterizing results of the focus quality metric within the subsets, the focus quality measure is reported for each of the sub-regions in the zone or subset of which the sub-regions are members. This can involve a test for acceptance threshold for the sub-regions or for the zones. Results are mapped as described.

Defined as a system, the digital microscopy system includes a slide scanner with a digital camera and automatic focus control operable to produce microscopic pixel data files containing digital images of tissue samples, for presentation on a digital display, a processor programmed to generate from the pixel data files an image assessment map having sub-regions corresponding to sub-regions in the images, a display operable to present selected ones of the digital images together with corresponding image assessment maps, wherein the image assessment maps visibly represent local focus quality over a range, and wherein the image assessment maps apply different focus quality assessment criteria, on a zone-by-zone basis to zones that are distinguished by similarities and differences in features appearing in the zones. The processor is programmed numerically to analyze pixel values in at least a test area of an image according to a first measure that correlates with focus quality and numerically to analyze the pixel values according to a second measure that correlates with similarity of structural characteristics, wherein the test area is logically divided into spatial sub-regions wherein groups of locally adjacent pixels that have characteristic values according to the second measure are associated together as zones, and wherein the processor determines a focus quality acceptance criteria that is distinct in each of the zones and is determined from a range of focus quality values found within sub-regions with similar structural characteristics.

The foregoing disclosure defines general aspects and exemplary specific aspects of the subject invention. However the invention is not limited to the embodiments disclosed as examples. Reference should be made to the appended claims rather than that the forgoing description of preferred embodiments, to assess the scope of the invention in which exclusive rights are claimed.

What is claimed is:

1. A method for analyzing images in digital format, wherein the images contain features of varying sizes and shapes, the method comprising:
analyzing pixel values in at least a test area of an image according to at least one measure, thereby obtaining measurement values that vary across the test area;
dividing the test area into spatial sub-regions that encompass groups of local pixels and determining for each of the sub-regions a characteristic value of the measurement values;
associating together adjacent ones of the sub-regions having characteristic values within a predetermined threshold of difference, thereby defining zones in the test area containing one or more sub-regions;
determining for respective said zones an acceptance criteria based on the measurement values of the sub-regions in the respective zone, and applying the acceptance criteria to rate the sub-regions in the zones according to the acceptance criteria determined for the zones in which the sub-regions are located.

2. The method of claim 1, wherein the measurement values are determined from application of at least one measure that correlates at least partly with image quality and at least one measure that correlates at least partly with differences of structural characteristics appearing in the image, and wherein said measures are obtained by executing one of a same algorithm, different algorithms, and a same algorithm with differences of at least one of scale factor, pixel pitch and orientation.

3. The method of claim 2, wherein a first said measure produces values that vary with focus accuracy and a second said measure produces values that vary among areas of the image that contain different visible structures.

4. The method of claim 1, wherein the measure includes a focus assessment measurement selected from the set consisting of derivative-based algorithms, statistical algorithms, histogram-based algorithms and intuitive algorithms.

5. The method of claim 1, wherein the measure includes determining a Brenner gradient for at least a subset of x, y pixel positions in a tissue area of a microscopic slide image.

6. The method of claim 1, wherein the measure includes a structure similarity measurement selected from the set consisting of affine transformation, blob detection, edge detection, corner detection, spatial periodicity, convolution masking and scaling.

7. The method of claim 1, wherein the measure includes applying a Laplacian convolution matrix.

8. The method of claim 5, wherein the measure includes applying a Laplacian convolution matrix.

9. The method of claim 2, further comprising generating an image map wherein ratings of the sub-regions in the zones according to an acceptance criteria are visibly represented, whereby the image map indicates a distribution of higher and lower quality areas within the zones.

10. The method of claim 2, wherein the first measure varies with accuracy of focus and further comprising generating an image map wherein ratings of the sub-regions in the zones according to an acceptance criteria are visibly represented, whereby the image map indicates a distribution of higher and lower focus accuracy within the zones.

11. The method of claim 9, further comprising displaying the image map in conjunction with display of the image.

12. The method of claim 9, further comprising at least temporarily applying the image map over the image for identifying sub-regions of higher and lower focus accuracy.

13. The method of claim 11, further comprising providing color variations in the image map corresponding to a span of ratings according to the acceptance criteria.

14. The method of claim 1, further comprising imposing a pass/fail acceptance criterion and queuing new images for images that at least partly fail said pass/fail acceptance criterion.

15. A method for assessing images in digital format, wherein the images can contain features of varying sizes and shapes, the method comprising:
analyzing pixel values in at least a test area of an image according to at least one measure correlated with image quality, thereby obtaining quality values that vary across the test area;
dividing the test area into spatial sub-regions that encompass groups of local pixels, and determining a quality measure for the sub-regions that characterizes the quality values found in the sub-regions;
analyzing pixel values in the test area according to at least one measure correlated with variations of image structure, and thereby obtaining structure variable values that vary across the test area;
associating together adjacent ones of the sub-regions in which the structure variable values are found to fall within a predetermined threshold of difference, thereby defining zones in the test area having similar structural attributes;
determining a range of image quality values of the sub-regions within the zones, wherein the ranges of image quality values can differ from one of the zones to another of the zones;
imposing a quality acceptance criteria on a zone by zone basis; and
grading the sub-regions in each zone according to the quality acceptance criteria applicable to the zone in which the sub-region is located.

16. The method of claim 15, wherein the quality measure includes at least one measure of focus.

17. The method of claim 16, wherein the images are microscopic digital images of samples for pathological or histological analysis, wherein the quality measure includes a Brenner gradient such that the quality measure varies with accuracy of focus, and wherein the structure variable includes a Laplacian transform such that the structure variable values distinguish associate and distinguish between zones by similarities and differences in depicted tissues.

18. The method of claim 15, wherein the quality acceptance criteria for respective ones of the zones are determined by statistical grading of the image quality values found said respective ones of the zones.

19. A method for displaying a focus quality assessment of a digital image comprising an array of pixel values, comprising:
subdividing at least a test area of the image into sub-regions;
applying a focus quality metric to the sub-regions;
applying an image structure classifier process to the sub-regions;
associating together the sub-regions as members of at least two groups distinguished as sub-regions that produced comparable results from the image structure classifier;
scaling results of the focus quality metric separately for said at least two subsets, and thereby producing for each subset a range that characterizes results of the focus quality metric within the subsets; and,
reporting a focus quality measure for each of the sub-regions within the range characterizing the results of the focus quality metric for the subset of which the sub-regions are members.

20. The method of claim 19, further comprising assessing a quality of focus of one of said image, at least one of said subsets, and at least one of said sub-regions according an acceptance threshold.

21. The method of claim 19, further comprising assessing a quality of focus of one of at least one of said subsets, and at least one of said sub-regions, and mapping a result of said assessing as one of color and shading of a silhouette of the image, wherein the silhouette is at least selectively displayed in conjunction with a display of said image and overlaid on the image.

22. A digital microscopy system comprising:
a slide scanner with a digital camera and automatic focus control operable to produce microscopic pixel data files containing digital images of tissue samples, for presentation on a digital display,
a processor programmed to generate from the pixel data files an image assessment map having sub-regions corresponding to sub-regions in the images,
a display operable to present selected ones of the digital images together with corresponding image assessment maps,
wherein the image assessment maps visibly represent local focus quality over a range, and wherein the image assessment maps apply different focus quality assessment criteria, on a zone-by-zone basis to zones that are distinguished by similarities and differences in structural features appearing in the zones.

23. The system of claim 22, wherein the processor is programmed numerically to analyze pixel values in at least a test area of an image according to a first measure that correlates with focus quality and numerically to analyze the pixel values according to a second measure that correlates with similarity of structural characteristics, wherein the test area is logically divided into spatial sub-regions wherein groups of locally adjacent pixels that have characteristic values according to the second measure are associated together as zones, and wherein the processor determines a focus quality acceptance criteria that is distinct in each of the zones and is determined from a range of focus quality values found within sub-regions with similar structural
